(19) United States
(12) Patent Application Publication
(10) Pub. No.: US 2006/0147885 A1
(43) Pub. Date: Jul. 6, 2006

(54) Educational mnemonic apparatus

(76) Inventor: Bettye J. Crawley Brown, Hazlehurst, GA (US)

Correspondence Address: HISCOCK & BARCLAY, LLP, 2000 HSBC PLAZA, ROCHESTER, NY, 14604-2404, US

(21) Appl. No.: 11/293,712

(22) Filed: Dec. 1, 2005

Related U.S. Application Data
(60) Provisional application No. 60/632,497, filed on Dec. 2, 2004.

(51) Int. Cl. G09B 19/00

(52) U.S. Cl. 434/236

(57) ABSTRACT

The invention comprises, in one form thereof, a set of desk accessories having a common theme. The theme is chosen to promote certain values in the classroom or office setting. These values may include diversity in the classroom or workplace, the promotion of various roles different members of the community have on the educational environment, etc.

### CROSS-REFERENCE TO RELATED APPLICATIONS

This application claims priority from U.S. Provisional Patent Application Ser. No. 60/632,497, filed Dec. 2, 2004.

### FIELD OF THE INVENTION

This invention relates to desk accessories and educational tools.

### BACKGROUND OF THE INVENTION

The invention relates to the field of desktop accessories and the field of educational equipment. There are a large number of items in the classroom that are used throughout the day by students and teachers. Such items include desk accessories such as staplers, scissors, pencil holders, tape dispensers, etc. While these tools may be used in the classroom, the tools do not necessarily teach lessons or promote values. The primary purpose of other items in the classroom may be to promote values and teach lessons, however they are not necessarily used as often as desk accessories and the like and thus may be more easily ignored. What is needed in the art is often-used classroom items such as desk accessories having features that promote values or teach lessons.

A number of items having secondary features are described in the art. For instance, U.S. Pat. No. 4,969,821 (Smith) discloses a display container with a group of figurines on the top of the container. The device is intended to be entertaining and to promote health awareness. However, the value of health awareness is promoted by a single item: a container that is designed specifically for prophylactics.

U.S. Pat. No. 4,561,184 (Fujitani) discloses a school utensil that is a combination of a compass, divider, ball point pen, and a toy such as a robot or doll. Futitani's utensil is meant to be entertaining, not to promote values or teach lessons.

U.S. Pat. No. 4,468,146 (Tabachnik) discloses a crayon holder in the shape of a figurine. The figurine may represent common occupations such as a fireman, a policeman, a nurse, etc. The purpose of Tabachnik's crayon holder is to make it easier for a child to hold a crayon and for the holder to be attractive to a child. There is no educational aspect to the crayon holder.

U.S. Pat. No. 6,165,035 (Avner) discloses a number of exterior covers in the shape of animals, plants, vehicles, buildings, etc. to be used with medical equipment. The covers are meant to have the affect of reducing the intimidation created by medical equipment, however they do not promote values or teach lessons with everyday classroom items.

U.S. Pat. No. 3,867,971 (Hazan) discloses a container combined with a figurine and is meant to be entertaining, not educational.

While the patents described here disclose figurines integrated with containers and utensils such as pens, and Smith's container is designed to promote awareness of a specific topic, they do not disclose or suggest a plurality of desk accessories that promote educational topics or socioeconomic values.

Therefore, often-used classroom items such as desk accessories having features that promote values or teach lessons are desired in the art.

Further, a plurality of various often-used classroom items that promote a common theme is desired in the art.

### SUMMARY OF THE INVENTION

The invention comprises, in one form thereof, a set of desk accessories having a common theme. The theme is chosen to promote certain values in the classroom or office setting. These values may include diversity in the classroom or workplace, the promotion of various roles different members of the community have on the educational environment, etc.

In one particular embodiment, the invention comprises an educational assistance set including a stapler that has a clear body portion with an opening, an internal chamber, and a first graphic insert positioned in the chamber so that a first graphical element of a message is presented, a stapler that has a clear body portion with an opening, an internal chamber, and a second graphic insert positioned in the chamber so that a second graphical element of a message is presented, and a stapler that has a clear body portion with an opening, an internal chamber, and a third graphic insert positioned in the chamber so that a third graphical element of a message is presented. The first graphical element represents the role of a teacher in the educational process and the second graphical element represents the role of a parent in the educational process.

An advantage of the present invention is that it comprises often-used classroom items such as desk accessories that have features that promote values or teach lessons.

A further advantage of the present invention is that it comprises a plurality of various often-used classroom items that promote a common theme.

### BRIEF DESCRIPTION OF THE DRAWINGS

The above-mentioned and other features and advantages of this invention, and the manner of attaining them, will become apparent and be better understood by reference to the following description of particular embodiments of the invention in conjunction with the accompanying drawings, wherein:

FIGS. 1-6 are several views of a number of desk accessories configured according to a first embodiment of the invention; and

FIGS. 7-10 are several views of a number of desk accessories configured according to a second embodiment of the invention.

Corresponding reference characters indicate corresponding parts throughout the several views. The examples set out herein illustrate several embodiments of the invention but should not be construed as limiting the scope of the invention in any manner.

### DETAILED DESCRIPTION

Referring to the figures, there is shown the educational assistance set of the present invention.

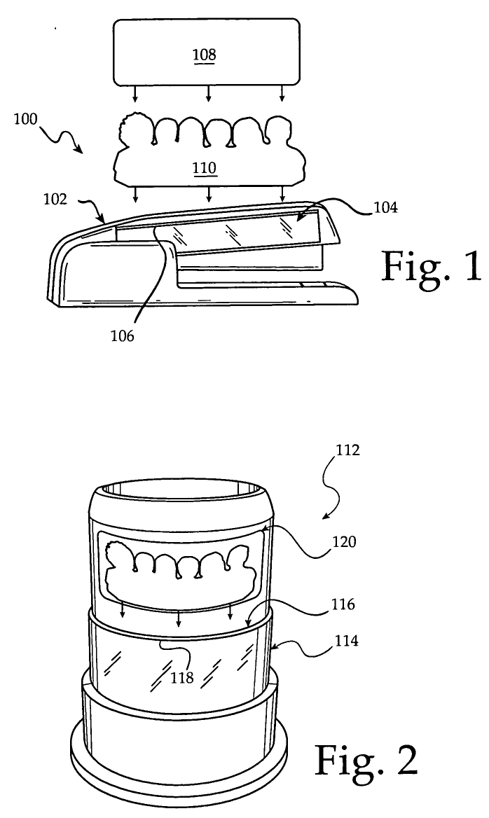

FIG. 1 shows a stapler according to a particular embodiment of the invention. The stapler 100 includes a transparent casing or outer body portion 102 and a chamber 104. An opening 106 in the outer body portion 102 provides access to the chamber 104. A first graphical insert 108 is configured to slide through the opening 106 into the chamber 104. In this particular embodiment, the first insert 108 is a background that abstractly represents a blue sky with white clouds. A second graphical insert 10 is configured to fit in the chamber 104 over the first insert 108. The second insert 10 depicts a diverse group of kids in this particular embodiment. The inserts promote the idea of accepting diversity in the classroom. Further inserts may also be added to further promote the idea. Alternatively, the inserts could depict other ideas such as an image that depicts a teacher and a parent collaborating in their respective roles in the educational process. In the current embodiment, the inserts 108 and 10 are comprised of a flexible plastic so they may be shaped to fit the contours of the stapler 100. Further, the second insert 10 and any further inserts included are cut away to expose at least a portion of the first insert 108 as shown in the figures. Alternatively, the second insert 10 is at least partly transparent or translucent to thereby expose at least a portion of the first insert 108.

Alternatively to providing the opening 106 in the outer body portion 102, the outer body portion 102 is removed from the stapler 100 before assembling the inserts 108 and 110. The inserts 108 and 10 are then affixed to the stapler 100 and the outer body portion 102 is affixed to the stapler 100 over the inserts 108 and 110.

FIG. 2 shows a pencil/paper clip holder 112. The holder 112 includes an outer body portion 114 and a chamber 116. An opening 118 provides access to the chamber 116. Multiple inserts 120 are configured to slide through the opening 118 into the chamber 116. The inserts 120 depict a background and a scene that coincide with the inserts 108 and 110 in the stapler 100 in order to further promote that idea. In the current embodiment, the inserts 120 are comprised of a flexible plastic so they may be shaped to fit the contours of the holder 112. Further, the outermost inserts are cut away to expose at least a portion of the innermost insert as shown in the figures. Alternatively, the outermost inserts are at least partly transparent or translucent to thereby expose at least a portion of the innermost insert.

Alternatively to providing the opening 118 in the outer body portion 114, the outer body portion 114 is removed from the holder 112 before assembling the inserts 120. The inserts 120 are then affixed to the holder 112 and the outer body portion 114 is affixed to the holder 112 over the inserts 120.

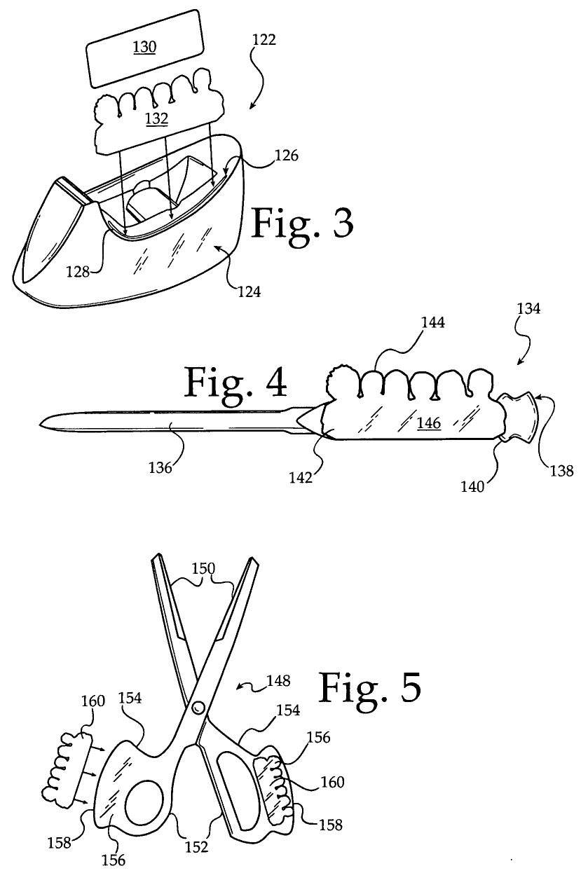

FIG. 3 shows a tape dispenser 122. The tape dispenser 122 includes an outer body portion 124 and a chamber 126. An opening 128 in the outer body portion 124 provides access to the chamber 126. A first graphical insert 130 is configured to slide through the opening 128 into the chamber 126. In this particular embodiment, the first insert 130 is a background that coincides with insert 108 used with the stapler 100. A second graphical insert 132 is configured to fit in the chamber 126 over the first insert 130. The second insert 132 coincides with the insert 110 used with stapler 100. In the current embodiment, the inserts 130 and 132 are comprised of a flexible plastic so they may be shaped to fit the contours of the tape dispenser 122. Further, the second insert 132 and any further inserts included are cut away to expose at least a portion of the first insert 130 as shown in the figures. Alternatively, the second insert 132 is at least partly transparent or translucent to thereby expose at least a portion of the first insert 130.

Alternatively to providing the opening 128 in the outer body portion 124, the outer body portion 124 is removed from the tape dispenser 122 before assembling the inserts 130 and 132. The inserts 130 and 132 are then affixed to the tape dispenser 122 and the outer body portion 124 is affixed to the tape dispenser 122 over the inserts 130 and 132.

FIG. 4 shows a letter opener 134 having a blade portion 136 and a handle portion 138. The handle portion 138 includes an outer body portion 140 and a chamber 142. An opening 144 allows insert(s) 146 to slide into the chamber 142. The insert(s) 146 coincide with the inserts 108 and 110 to further promote the ideas those inserts promote on stapler 100. In the current embodiment, the inserts 146 are comprised of a flexible plastic so they may be shaped to fit the contours of the handle portion 138. Further, the outermost inserts are cut away to expose at least a portion of the innermost insert as shown in the figures. Alternatively, the outermost inserts are at least partly transparent or translucent to thereby expose at least a portion of the innermost insert.

Alternatively to providing the opening 144 in the outer body portion 140, the outer body portion 140 is removed from the handle portion 138 before assembling the inserts 146. The inserts 146 are then affixed to the handle portion 138 and the outer body portion 140 is affixed to the handle portion 138 over the inserts 146.

FIG. 5 shows a pair of scissors 148 having a blade portion 150 and a handle portion 152. The handle portion 152 includes an outer body portion 154 and a chamber 156. An opening 158 allows insert(s) 160 to slide into the chamber 156. The insert(s) 160 coincide with the inserts 108 and 110 to further promote the ideas those inserts promote on stapler 100. In the current embodiment, the inserts 160 are comprised of a flexible plastic so they may be shaped to fit the contours of the handle portion 152. Further, the outermost inserts are cut away to expose at least a portion of the innermost insert as shown in the figures. Alternatively, the outermost inserts are at least partly transparent or translucent to thereby expose at least a portion of the innermost insert.

Alternatively to providing the opening 158 in the outer body portion 154, the outer body portion 154 is removed from the handle portion 152 before assembling the inserts 160. The inserts 160 are then affixed to the handle portion 152 and the outer body portion 154 is affixed to the handle portion 152 over the inserts 160.

It should be noted that the use of multiple inserts in the current embodiment gives the scenes a small amount of depth to thereby give them a somewhat three-dimensional look. It should be further noted that when the outer body portion is configured to be removable, it may comprise multiple pieces for easier assembly.

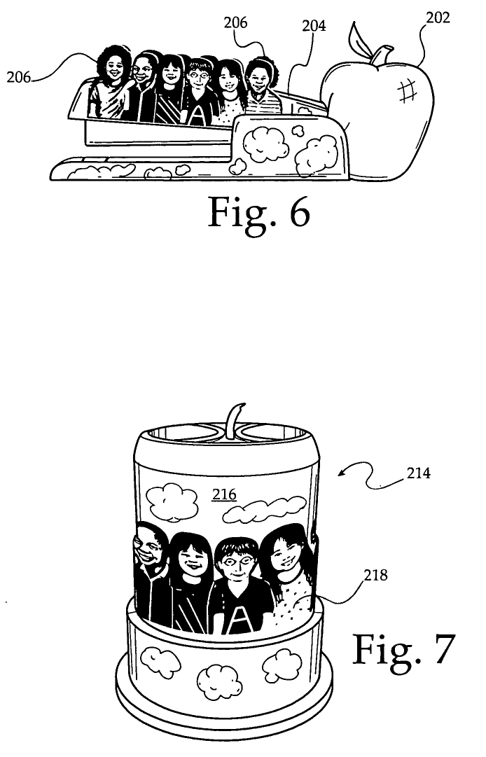

FIGS. 6-10 show another embodiment of an educational assistance set. In this particular embodiment, the stapler 200, shown in FIG. 6, is molded to include an integral apple shape 202 at one end to promote the education aspect of the idea being promoted. A background 204 is painted on the stapler 200 and a scene 206 depicting a diverse group of kids is painted on the sides of the stapler 200. The stapler 200 may be molded such that the kids in the scene 206 extend beyond the edges of the stapler 200 in order to give them a somewhat three-dimensional look.

FIG. 7 shows a pencil/paper clip holder 214 according to the present embodiment. A background 216 is painted on the holder 214 and a scene 218 depicting a diverse group of kids is painted over the background 216 to further promote ideas that coincide with those of the stapler 200.

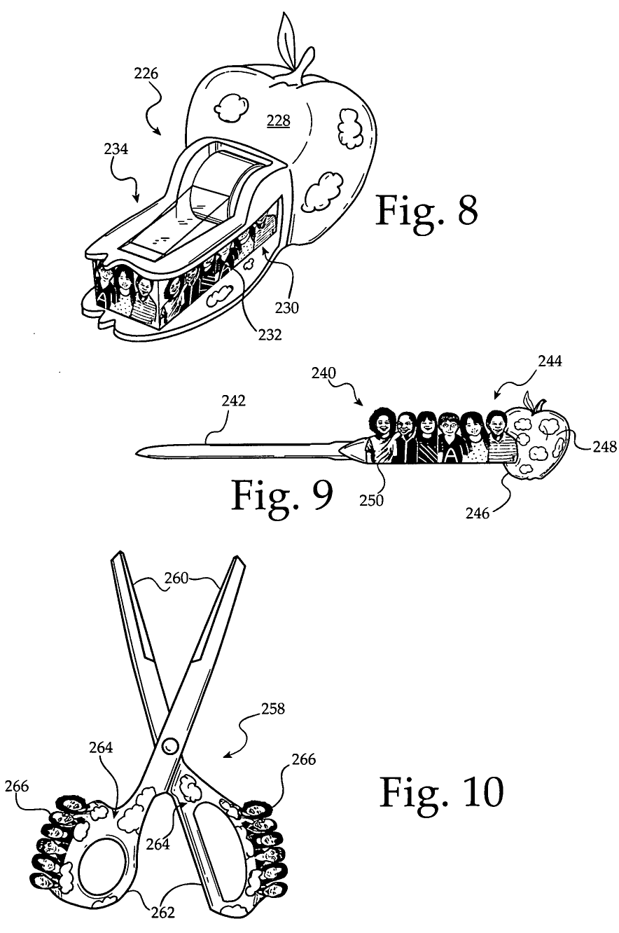

FIG. 8 shows a tape dispenser 226 according to the present embodiment. The tape dispenser 226 is molded to include an integral apple shape 228 at one end to promote the education aspect of the idea being promoted. A background 230 is painted on the tape dispenser 226 and a scene 232 depicting a diverse group of kids is painted on the sides of the tape dispenser 226. The tape dispenser 226 may be molded such that the kids in the scene 232 extend beyond the edges of the tape dispenser 226 in order to give them a somewhat three-dimensional look. Alternatively, the body of the tape dispenser 226 may be molded into a second apple shape 234 as shown in FIG. 8.

FIG. 9 shows a letter opener 240 having a blade portion 242 and a handle portion 244. The handle portion 244 is molded to include an integral apple shape 246 at one end to promote the education aspect of the idea being promoted. A background 248 is painted on the handle portion 244 and a scene 250 depicting a diverse group of kids is painted on the sides of the handle portion 244. The handle portion 244 may be molded such that the kids in the scene 250 extend beyond the edges of the handle portion 244 in order to give them a somewhat three-dimensional look.

FIG. 10 shows a pair of scissors 258 having a blade portion 260 and a handle portion 262. A background 264 is painted on the handle portion 262 and a scene 266 that coincides with the scene 206 is painted on the sides of the handle portion 262. The handle portion 262 may be molded such that the kids in the scene 266 extend beyond the edges of the handle portion 262 in order to give them a somewhat three-dimensional look.

In the present embodiment, the backgrounds and scenes are painted onto the desk accessories. Alternatively, the backgrounds and the scenes are stickers that are adhered to the outer surfaces of the desk accessories in the education assistance set.

The themed items described in the embodiments serve to reinforce ideas such as the acceptance of diversity in the classroom and the importance of the roles different people play in the educational process when the items are used by children and other individuals. Examples of important roles that may be depicted include the obvious role of the teacher, the parents' role in supporting their child, and the administrations role in discipline and providing a safe educational environment. Further themes may be imagined, such as a flowers theme including a variety of flowers and possibly the names of the flowers.

It should be particularly noted that while certain desk accessories have been described in the embodiments, other desk accessories and classroom materials may also be used in the invention. Examples include a ruler, a calculator, a dry erase board, pens and pencils, a book cover, a bank, a trash bin, a tissue dispenser, book ends, and portfolios.

It should be further particularly noted that the themed items described in the embodiments may be molded to include other shapes besides an apple shape. The shapes may reinforce the idea promoted by the theme of the desk set and may be in the form of flowers, sports equipment, cartoon characters, or any symbol associated with a particular theme.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A set of educational desk accessories, comprising:
a plurality of desk accessories, wherein each of said desk accessories has an outer surface;
a scene depicted on the outer surface of one or more of said desk accessories;
wherein each of said desk accessories is selected from the group consisting of a stapler, a pencil and paper clip holder, a tape dispenser, a letter opener, a pair of scissors, a ruler, a calculator, a dry erase board, pens and pencils, and book covers.

2. The set of educational desk accessories of claim 1, wherein one or more of said desk accessories is molded to emphasize said scene.

3. The set of educational desk accessories of claim 1, wherein said scene represents an educational issue.

4. The set of educational desk accessories of claim 3, wherein said educational issue is the acceptance of diversity in the classroom.

5. The set of educational desk accessories of claim 3, wherein said educational issue is the importance of the roles certain people play in the educational process.

6. A set of desktop items, comprising:
a plurality of desktop items, wherein each of said desktop items has an outer surface;
a scene depicted on the outer surface of one or more of said desktop items;
wherein said scene promotes a particular educational value.

7. The set of desktop items of claim 6, wherein said educational value is the acceptance of diversity in the classroom.

8. The set of desktop items of claim 6, wherein said educational value is the importance of the roles certain people play in the educational process.

9. The set of desktop items of claim 6, wherein each of said desktop items is selected from the group consisting of a stapler, a pencil and paper clip holder, a tape dispenser, a letter opener, a pair of scissors, a ruler, a calculator, a dry erase board, pens and pencils, and book covers.

10. An educational assistance set comprising:
a plurality of desk accessories, each having a clear body portion with an opening, an internal chamber, and a first graphic insert positioned in said chamber so that a first graphical element of a message is presented.

11. The educational assistance set of claim 10, wherein each of said desk accessories further comprise second graphic insert positioned in said chamber so that a second graphical element of a message is presented.

12. The educational assistance set of claim 11, a wherein each of said desk accessories further comprise a third graphic insert positioned in said chamber so that a third graphical element of a message is presented.

13. The educational assistance set of claim 11, wherein said first graphical element represents the role of a teacher in the educational process and the second graphical element represents the role of a parent in the educational process.
